(19) United States
(12) Patent Application Publication
(10) Pub. No.: US 2012/0030135 A1
(43) Pub. Date: Feb. 2, 2012

(54) LITERARY WORK OF AUTHORSHIP HAVING AN EMBEDDED RECOMMENDATION

(75) Inventors: Kevin Michael Weiss, HOUSTON, TX (US); Keith Ogorek, Indianapolis, IN (US)

(73) Assignee: AUTHOR SOLUTIONS INC., Fremont, CA (US)

(21) Appl. No.: 12/846,846

(22) Filed: Jul. 30, 2010

(51) Int. Cl. G06Q 30/00; G06F 3/048

(52) U.S. Cl. 705/347; 715/716

(57) ABSTRACT

In one embodiment, the method includes providing a rich media file for a literary work of authorship in an electronic medium of expression and generating a recommendation of an external source of information on one of a contextually relevant basis, a geospatially relevant basis, and a user-centric basis. The method also includes generating a contextually relevant suggestion based on a contextual meta-data associated with the literary work when the recommendation is contextually relevant and generating a geospatially relevant suggestion dynamically based on a meta-data associated with a current geo-spatial location of a rich-media player device presently displaying the literary work of authorship when the recommendation is geospatially relevant. Further, the method includes generating a user-centric recommendation dynamically based on a reader meta-data associated with a profile of a user currently accessing the literary work of authorship through the rich-media player device when the recommendation is user-centric.

### FIELD OF TECHNOLOGY

This disclosure relates generally to electronic devices and, in one example embodiment, to a literary work of authorship having an embedded recommendation.

### BACKGROUND

A merchant (e.g., a bookstore, a publisher, etc.) may have an electronic version of a literary work of authorship (e.g., a book, a poem, a novel, a text, etc.). A user (e.g., a potential buyer, a reader, etc.) may access the literary work of authorship through a device (e.g., a PDA device, an e-reader device, etc.). The user may be interested in relevant information (e.g., additional reading material, relevant audio and video sources, information associated with purchasing this or other literary works) related to the literary work he is currently accessing.

The user may not be aware of the relevant information, and/or may have to manually research other literary works extensively to arrive at the additional relevant information that may be of use and/or interest to the user. This may be a time consuming and inefficient task. For example, the user may have to conduct research on a separate website or search engine (e.g., Google®, Yahoo®, etc.) to research relevant information.

The user may not be aware of relevant additional information, and may thus loose an opportunity to access information potentially of interest to the user. As a result, the user may neglect or postpone a decision to access and/or purchase the current or additional literary works because he/she may not be aware of relevant information related to the literary work, and/or may not be able to access it conveniently. Therefore, the merchant may lose valuable incremental revenue opportunities.

### SUMMARY

Disclosed are method, system and an apparatus to provide a rich-media file for a literary work of authorship in an electronic medium of expression. In one aspect, a method includes providing a rich-media file for a literary work of authorship in an electronic medium of expression. The method also includes generating a recommendation of an external source of information on one of a contextually relevant basis, a geospatially relevant basis, and/or a user-centric basis. The method further also includes generating a contextually relevant suggestion based on a contextual meta-data associated with the literary work when the recommendation is contextually relevant. The contextual meta-data data may be one or more of a word of the literary work, a phrase of the literary work, a sentence of the literary work, a paragraph of the literary work, a page of the literary work, a chapter of the literary work, a section of the literary work, a summary of the literary work, an author of the literary work, a publisher of the literary work, a retail price of the literary work, a subject of the literary work, a genre of the literary work, a category of the literary work, a publishing year of the literary work and a theme of the literary work.

In addition, the method includes generating a geospatially relevant suggestion dynamically based on a meta-data associated with a current geo-spatial location of a rich-media player device presently displaying the literary work of authorship when the recommendation is geospatially relevant. The meta-data associated with the current geo-spatial location may be one or more of a specific geo-spatial location of the rich-media player, a predefined radius of the specific geo-spatial location of the rich-media player, a geospatial proximity to a landmark and a geospatial proximity to a user-specified location.

The method also includes generating a user-centric recommendation dynamically based on a reader meta-data associated with a profile of a user currently accessing the literary work of authorship through the rich-media player device when the recommendation is user-centric. The reader meta-data may be one or more of a behavioral attribute of the user, a historical analysis based on previous reading history of the user, an interest of the user identified through self-identification and a social graph of the user.

The method may also include refreshing the meta-data automatically when an update is transmitted to the rich-media player device when accessing the literary work of authorship. The behavioral attribute may be one or more of a speed of reading a portion of the literary work of authorship, a scrolling speed, a display time and an access frequency of a page of the literary work. The historical analysis based on previous reading history of the user may be one or more of an access frequency of a particular author, an access frequency of a particular genre, an access frequency of a particular subject matter, and an access frequency of a particular theme by the user of the rich-media device.

The social graph of the user may be one or more of a behavior of the user on a social community accessible through the rich-media device, a behavior of a set of individuals associated with the user on the social community, an attribute of the user associated with the social community, an attribute of the set of individuals associated with the user on the social community, a set of preferences voiced by the user on the social community, a set of preferences voiced by the set of individuals associated with the user on the social community, an age of the user, an age of the set of individuals associated with the user, a set of demographics of the user based on a usage of the social community, a set of demographics of the set of individuals associated with the user based on the usage of the social community, a set of trends of the user based on the usage of the social community, a set of trends of the set of individuals associated with the user based on the usage of the social community, and an information based on a set of groups associated with the user on the social community accessible through the rich-media device.

The method may include determining a meta-data identifier information associated with the literary work of authorship. The method may also include associating a first relevant external data with the meta-data identifier information based on the contextual meta-data. In addition, the method may also include automatically generating the contextually relevant suggestion based on the first relevant external data through an indicator on a user interface of the rich-media player device. The method may further also include permitting the user to access the contextually relevant suggestion through the indicator on the user interface of the rich-media player. The method may also include generating a set of contextually relevant suggestions as a list on the user interface of the rich-media player device when a second relevant external data is detected. The method further may also include permitting the user to select a preferred suggestion through the list on the user interface of the rich-media player.

Furthermore, the method may include determining a language of a current literary work through a semantic analysis. The method may also include selecting an appropriate language from a list of predetermined languages based on the semantic analysis. In addition, the method may include analyzing a set of generated recommendations based on the language of the literary work. The method may also include filtering the set of generated recommendations to display exclusively a recommendation in the language of the current literary work.

In addition, the method may include organizing the list of recommendations based on a predetermined criteria for relevance. The method may also include giving a higher priority on the list to a particular recommendation when the predetermined criteria for relevance is higher. The method further may also include giving a lower priority on the list to a particular recommendation when the predetermined criteria for relevance is lower. The predetermined criteria for relevance is based on one or more of a computerized algorithm created for relevance, a preference selected by the user, a language preference, the behavioral pattern of the user, the historical analysis of prior reading patterns of the user, the social graph of the user, the behavioral patterns of a set of similar users and a set of current events.

The method may include analyzing a set of generated recommendations for a set of translations pertaining to the literary work. The method may also include filtering the set of generated recommendations to omit the language of the current literary work to display exclusively a list of recommendations for translations in a set of foreign languages. The method further may also include organizing the list of recommendations for translations based on a predetermined criterion for language preference.

The predetermined criteria for language preference may be based on one or more of user preferences for a particular set of languages, a computerized algorithm created for universal language preferences, a list of languages ranked by the number of speakers, a list of languages ranked by the number of users for a particular literary work, a list of languages based on the current geospatial location, a list of languages based on original language of the particular literary work, a list of languages based on the nationality of an author of the particular literary work, a list of languages based on the nationality of a publisher of the particular literary work, a list of languages based on a popularity of the particular literary work in a particular language, the behavioral pattern of the user, the historical analysis of prior reading patterns of the user, the social graph of the user, the behavioral patterns of a set of similar users and a set of current events.

In addition, the method may include authorizing a translation provider as an authorized translation provider when the translation provider has an agreement with a content owner associated with the literary work of authorship. The method may also include permitting the authorized translation provider to generate an alternative translation data associated with the literary work. The method further may include automatically associating the alternative translation data with the meta-data identifier information. The method may also include permitting the user to select a preferred translation through the list indicator on the user interface of the rich-media player.

Furthermore, the method may include authorizing a narration provider as an authorized narration provider when the narration provider has an agreement with a content owner associated with the literary work of authorship. The method may also include permitting the authorized narration provider to generate an alternative audio narration data associated with the literary work. In addition, the method may include analyzing a set of generated recommendations for a set of narrations pertaining to the literary work.

The method may also include organizing the list of recommendations for translations based on the predetermined criteria for relevance. The method further may include giving a higher priority for a narration in the language of the literary work based on the semantic analysis. The method may also include permitting the user to select a preferred narration through the list indicator on the user interface of the rich-media player.

The method may include permitting an authorized purchaser of the rich-media file to record an individualized narration of the literary work of authorship. The method may also include recognizing the authorized purchaser of the rich-media file as one of an authorized narration provider. In addition, the method may include analyzing a set of generated recommendations for a type of external data pertaining to the literary work. The method further may include organizing the list of recommendations for the type of external data based on the predetermined criteria for relevance.

The method may also include permitting the user to access the recommendation through the indicator on the user interface of the rich-media player device. The type of external data may be one of a translation data, a narration data, a graphics data, a video data, a music data, a purchase link, a fictional reading suggestion, a nonfictional reading suggestion and an information link. The purchase link may be a link to a commerce portal displaying a list of suggested reading material for purchase accessible through the user interface of the rich-media player device.

In addition, the method may include automatically generating the recommendation on the user interface of the rich-media player device through an alert. The method further may include situating the alert adjacent to a content of the rich-media file on the user interface. The method may also include permitting the user to select a preferred location for the alert based on a set of predefined automated alert-location options.

In another aspect, the method includes determining a contextually relevant meta-data associated with a rich media file for a literary work of authorship in an electronic medium of expression. The method also includes determining a geospatially relevant meta-data associated with a current geo-spatial location of a rich-media player device presently displaying the literary work of authorship. In addition, the method includes determining a reader meta-data associated with a profile of a user currently accessing the literary work of authorship through the rich-media player device. The method further includes associating an external source of information to one of the contextually relevant meta-data, the geospatially relevant meta-data and the reader meta-data. The method also includes generating a recommendation based on the external source of information.

Furthermore, the method may include determining a meta-data identifier information associated with the literary work of authorship. The method may also include associating the external source of information to the meta-data identifier information associated with the literary work of authorship. The method further may include analyzing a list of recommendations for a type of the external data associated with the literary work. In addition, the method may include organizing the list of recommendations for the type of the external data based on a predetermined criterion for relevance. The method may also include generating the list of recommendations through an alert on the user interface associated with the rich-media player device.

In yet another aspect, the method includes a rich-media file to store a literary work of authorship in an electronic medium of expression. The method also includes a circuitry to determine a content of the electronic medium of expression, to associate an external source of information with the content of the electronic medium of expression and to generate a set of recommendations based on one of a contextually relevant basis, a geospatially relevant basis and a user-centric basis. In addition, the method includes a filtering component to organize the set of recommendations based on a predetermined criteria for relevance. The method also includes a user interface to display the set of recommendations.

### BRIEF DESCRIPTION OF THE VIEWS OF DRAWINGS

Example embodiments are illustrated by way of example and not limitation in the figures of accompanying drawings, in which like references indicate similar elements and in which:

FIG. 1 illustrates a system view diagram of a rich-media player device generating recommendations based on a relevance, according to one or more embodiments.

FIG. 2 is a process flow diagram illustrating the steps involved in generating contextually relevant suggestion, according to one or more embodiments.

FIG. 3 is a process flow diagram illustrating the steps involved in generating geo-spatially relevant suggestion, according to one or more embodiments.

FIG. 4 is a process flow diagram illustrating the steps involved in generating alert of user-centric suggestion, according to one or more embodiments.

Other features of the present embodiments will be apparent from accompanying Drawings and from the Detailed Description that follows.

### DETAILED DESCRIPTION

Disclosed are method, system and an apparatus to provide a rich-media file for a literary work of authorship in an electronic medium of expression. Although the present embodiments have been described with reference to specific example embodiments, it will be evident that various modifications and changes may be made to these embodiments without departing from the broader spirit and scope of the various embodiments.

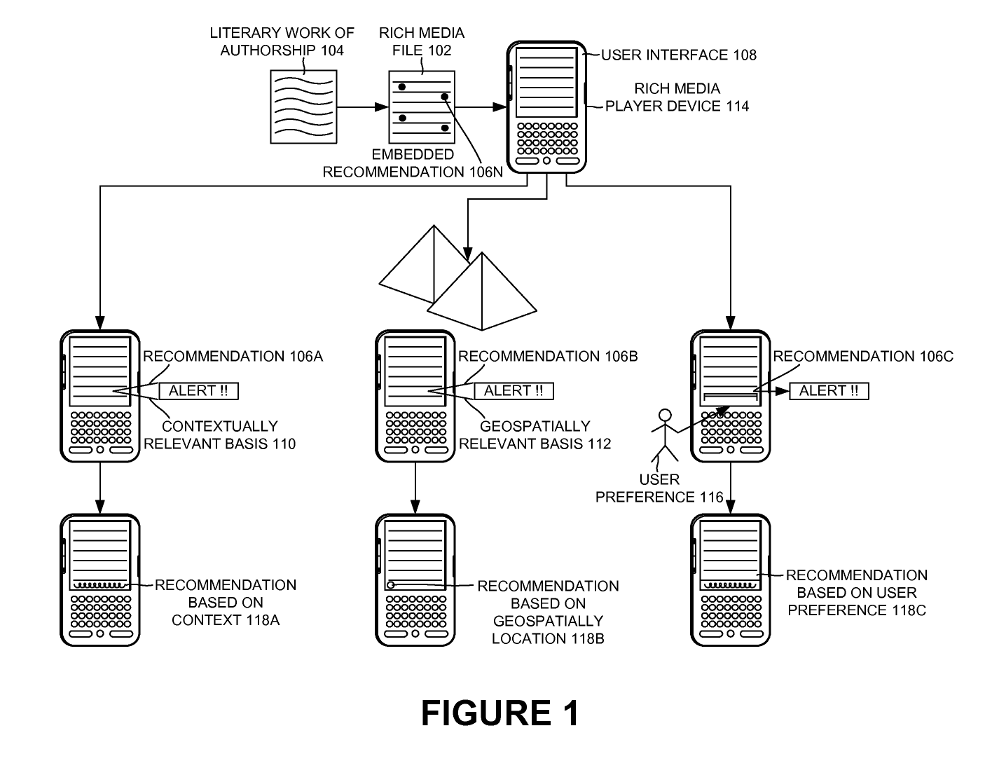

FIG. 1 illustrates a rich-media file 102 for a literary work of authorship in an electronic medium of expression. In one or more embodiments, the rich-media file 102 may be configured to store a literary work of authorship in an electronic medium of expression. In one or more embodiments, the electronic medium may be a portable electronic rich-media player device 114 customized for providing an information about a literary work of authorship 104 and providing a recommendation of an external source of information based on at least one of a contextually relevant basis, a geospatially relevant basis, and a user-centric basis. In one or more embodiments, the rich-media player device 114 as described herein may be configured to obtain information and provide recommendations by obtaining information from a server through a network. In one or more embodiments, the electronic device may be configured to communicate with the server through a wired interface and/or through a wireless interface. The rich-media player device 114 may have an interface such as a Universal Serial Bus (USB) for communicatively coupling to a wired interface and/or for communicatively coupling to a wireless network interface circuit.

In one or more embodiments, the rich-media player device 114 may be controlled through an operating system provided thereof. In one or more embodiments, the operating system may be configured to control functions of the rich-media player device 114 such as communication, display, power, user interface, etc. In one or more embodiments, the operating system may provide a user interface 108 for a user to input information and to obtain output in form of information, recommendations and the like.

In one or more embodiments, the user may be enabled to input data such as a word, a sentence, a phrase, a name of a place, etc. In one or more embodiments, the input data may be processed by the rich-media player device 114 and the server to generate a rich-media file 102 that includes a literary work of authorship. In one or more embodiments, the rich-media file 102 may be outputted on the user interface displayed on a display of the rich-media player device 114. In addition, in one or more embodiments, the rich media file 102 may include an embedded recommendation 106_{1-N} that provides external sources of information. In one or more embodiments, the external source of information may include, but not be limited to literary information (e.g., books, blogs), author information, author's location information, and literary information associated with a context of the user input.

In one or more embodiments, the embedded recommendation in the rich-media file 102 that includes an external source of information may be generated based on but not limited to a contextually relevant basis, a geospatially relevant basis, and a user-centric basis. In one or more embodiments, the rich-media file 102 may receive data from the literary work of authorship 104 from the server and may generate an embedded recommendation 106N. In one or more embodiments, the user interface 108 may be used to access the literary work of authorship through a device (e.g., a PDA device, an e-reader device, etc).

In an example embodiment, the rich-media player device 114 may be used as the user interface 108. The recommendation 106_{1-N} may be provided by the rich-media player device 114 based on contextually relevant basis 118A, geospatially relevant basis 118B and/or user-centric basis 118C. In one or more embodiments, the contextually relevant suggestion based on a contextual meta-data associated with the literary work may be generated when the recommendation is contextually relevant. The contextual meta-data may be, in one or more embodiments, one or more of a word of the literary work, a phrase of the literary work, a sentence of the literary work, a paragraph of the literary work, a page of the literary work, a chapter of the literary work, a section of the literary work, a summary of the literary work, an author of the literary work, a publisher of the literary work, a retail price of the literary work, a subject of the literary work, a genre of the literary work, a category of the literary work, a publishing year of the literary work and a theme of the literary work. In one or more embodiments, the rich-media player device 114 may be configured to generate a recommendation 106_{1-N} as an alert based on the contextually relevant basis 110.

In one or more embodiments, the geospatially relevant suggestion based on a meta-data associated with a current geo-spatial location of the rich-media player device 114 may be generated when the recommendation may be geospatially relevant. The meta-data associated with the current geo-spatial location may be, in one or more embodiments, a specific geo-spatial location of the rich-media player device 114, a predefined radius of the specific geo-spatial location of the rich-media player device 114, a geospatial proximity to a landmark and a geospatial proximity to a user-specified location. The rich-media player device 114 may generate a recommendation 106B and an alert when the meta-data is geospatially relevant 112.

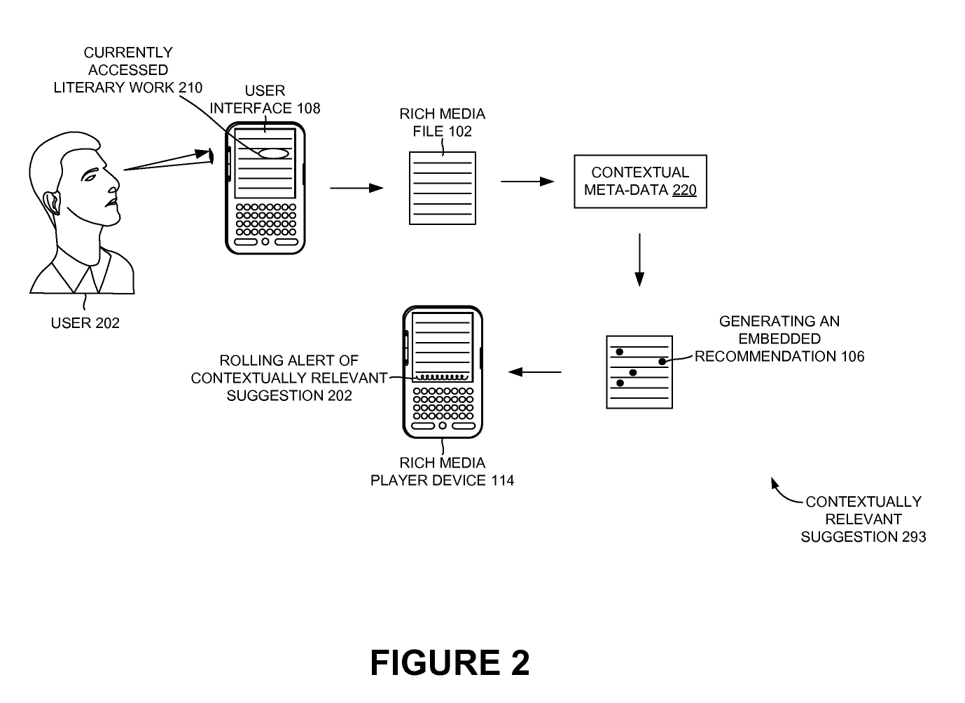

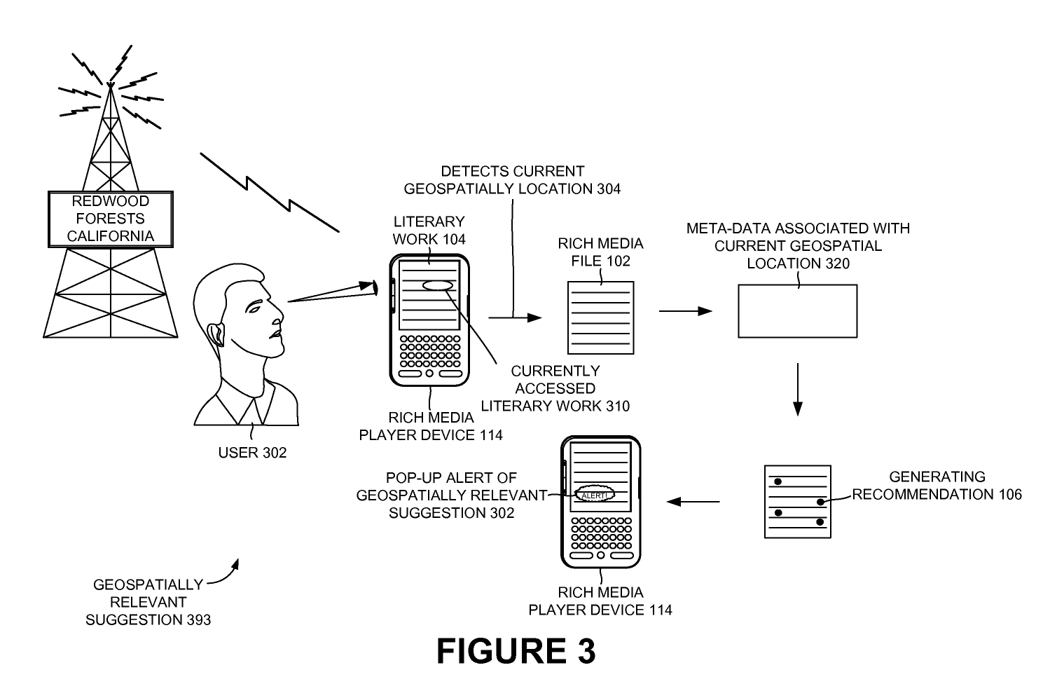

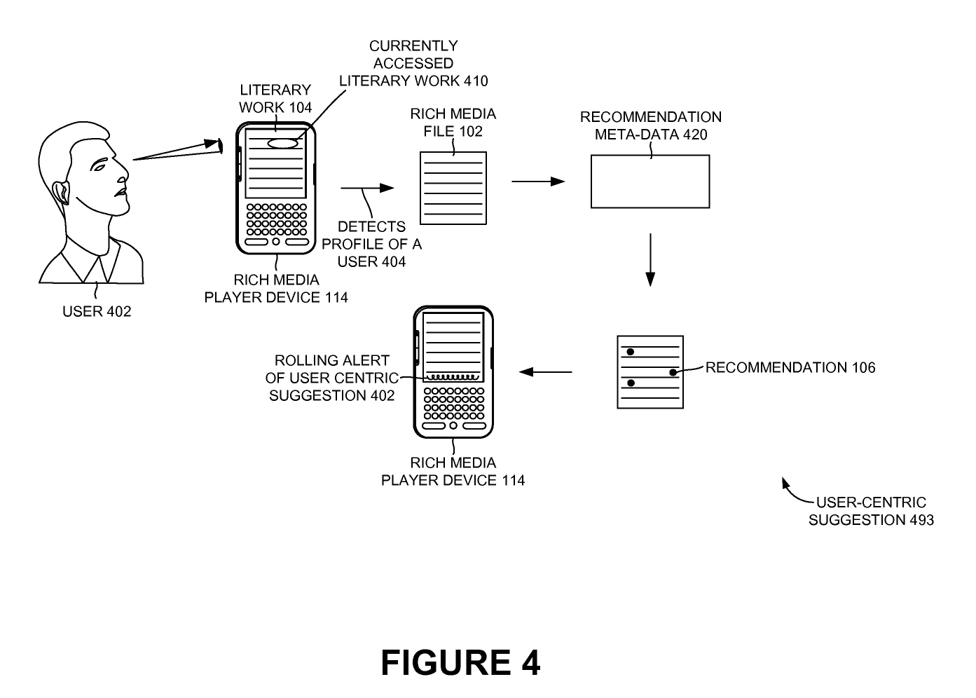

The user-centric recommendation may be generated dynamically based on a reader meta-data associated with a profile of a user currently accessing the literary work of authorship through the rich-media player device when the recommendation is user-centric. The reader meta-data may be, in one or more embodiments, a behavioral attribute of the user, a historical analysis based on previous reading history of the user, an interest of the user identified through self-identification and a social graph of the user. In one or more embodiments, the rich-media player device 114 may generate a recommendation 106C and an alert when the meta-data may be based on a user preference 116. Generating recommendations based on contextual based criteria, geospatial based criteria, and user preference based criteria may be explained in more detail in FIG. 2, FIG. 3 and FIG. 4 respectively.

FIG. 2 is a process flow diagram illustrating steps involved in generating a contextually relevant suggestion 293, according to one or more embodiments. In one or more embodiments, the user 202 may search and access any literary work 210. In one or more embodiments, the access information may be used for generating a rich-media file 102. In one or more embodiments, based on an analysis of the currently accessed literary work 210, a contextually relevant data and meta-data 220 associated with the contextually relevant data may be determined. Furthermore, based on the contextually relevant data and the contextual meta-data 220, recommendations may be generated and embedded in the rich-media file 102. Furthermore, the rich media file 102 may be illustrated as an alert on the user interface in a user-readable friendly format. In one example embodiment, the alert may be a rolling alert of a contextually relevant suggestion 202.

In one or more embodiments, the rolling alert may be a kind of alert where the user interface is configured to display recommendations in a moving pattern. In one or more embodiments, for example, a user may access an information associated with a game, say baseball, while reading a novel through the user interface. The rich-media player device 114 may communicate the access request to the server by obtaining information about baseball through the rich-media player device 114. The access information may be analyzed and communicated to a server to generate a rich-media file. Further, the server in association with the rich-media player device 114 may be configured to analyze the context of the input to determine a possible context in which the user would have been accessing information. In one example, the user may have tried to access information about baseball to know what a baseball game is like. In another example, the user may have tried to understand the rules of baseball. The server and the rich-media player device 114 may analyze the possibilities so as to determine a context for the information access. Furthermore, the server may determine information relevant to the context of user access and may generate a recommendation thereof.

Furthermore, the recommendations may be embedded into the rich-media file 102. In one example embodiment, the contextually relevant information for the baseball may include literary information related to baseball such as but not limited to various authors who have written books on baseball, various articles published about baseball, blogs about baseball and rules of baseball. In addition, the user interface may also display additional information like the publication date of various articles, category of the information baseball, theme, genre, etc. which may provide additional information to the user. Rolling alerts of baseball relevant terms may be generated and alerts may be displayed on the screen of the rich-media player device 114 for the user.

In one or more embodiments, a meta-data identifier information associated with the literary work of authorship may also be determined (e.g., baseball). A first relevant external data (e.g., books like baseball for all, baseball by John Doe) may be associated with the meta-data identifier information based on the contextual meta-data. The contextually relevant suggestion based on the first external data through an indicator may be automatically generated on the user interface of the rich-media player device 114 (rolling alert). The user may be permitted to access the contextually relevant suggestion through the indicator on the user interface of the rich-media player.

In one or more embodiments, the indicator may be, but not limited to, a hyperlink, and a sticky note. In one or more embodiments, a set of contextually relevant suggestions may be generated as a list on the user interface of the rich-media player device 114 when a second relevant external data is detected. The user 202 may be permitted to select a preferred suggestion through the list on the user interface of the rich-media player device 114.

FIG. 3 is a process flow diagram illustrating steps involved in generating geo-spatially relevant suggestion 393, according to one or more embodiments. In one or more embodiments, the user 302 may be enabled to access a literary work through the literary work being currently used through the user interface of the rich-media player device 114. In one or more embodiments, the rich-media player device 114 may be configured to detect the current geospatial location 304 of the user 202 and may communicate with the server to generate a rich-media file 102. In one or more embodiments, the accessed literary work 310 may be contextually tied to geospatial information to generate a recommendation using the accessed literary work based geospatial relevant information.

In one or more embodiments, the rich media file 102 may be generated with meta-data associated with current geospatial location 320. In one or more embodiments, the rich media file 102 may be embedded with recommendations and may generate the recommendations 106 based on information that are geospatially relevant to the accessed information. In one or more embodiments, the meta-data associated with the current geospatial location 320 may generate a recommendation 106 and may communicate with the rich-media player device 114 to generate an alert that includes a geospatially relevant suggestion 302.

For example, if the user wishes to access information on the California Redwoods through the user interface of the rich-media player device 114 while reading a novel, the access information may be communicated to the server to generate a rich-media file 102. The server and the rich-media player device 114 may analyze the content and the geospatial location to generate the content associated with the access information but relevant to the geospatial location.

The rich-media player device 114 may generate recommendations relevant to the California Redwoods, like authors who may have written books on the California Redwoods, various articles on the California Redwoods and information on places nearby, etc. The rich-media player device 114 may also display additional information like distances of different locations from the California Redwood, landmarks nearby and the current location of the user 302 etc.

FIG. 4 is a process flow diagram illustrating steps involved in generating an alert of user-centric suggestion, according to one or more embodiments. While the user 402 accesses the literary work 104 on the rich-media player device 114, the rich-media player device 114 may analyze a profile of the user 404 to generate meta-data 420 based on the user profile and/or preference. The meta-data 420 associated with the user preference may be used for generating a recommendation 106. In one or more embodiments, the recommendation may be embedded into the rich-media file 102 and communicated to the rich-media player device 114 to generate a rolling alert of the user centric suggestion.

In one or more embodiments, the meta-data may be refreshed automatically when an update is transmitted to the rich-media player device 114 when accessing the literary work of authorship. In one or more embodiments, behavioral attributes, historical analysis, and social graph may be obtained from the user profile and usage history in the rich media player device 114. In one or more embodiments, the behavioral attributes may be but not limited to a speed of reading a portion of the literary work of authorship, a scrolling speed, and a display time and an access frequency of a page of the literary work. The historical analysis of the user may be based on one or more of an access frequency of a particular author, an access frequency of a particular genre, an access frequency of a particular subject matter, an access frequency of a particular theme by the user of the rich-media device.

In one or more embodiments, the social graph of the user may a behavior of the user on a social community accessible through the rich-media device, a behavior of a set of individuals associated with the user of the social community, an attribute of the user associated with the social community, an attribute of the set of individuals associated with the user on the social community, a set of preferences voiced by the user on the social community, a set of preferences voiced by the set of individuals associated with the user on the social community, an age of the user, an age of the set of individuals associated with the user, a set of demographics of the user based on a usage of the social community, a set of demographics of the set of individuals associated with the user based on the usage of the social community, a set of trends of the user based on the usage of the social community, a set of trends of the set of individuals associated with the user based on the usage of the social community, and an information based on a set of groups associated with the user on the social community accessible through the rich-media device.

In one or more embodiments, a language of a current literary work may be determined through a semantic analysis. An appropriate language may be selected from a list of predetermined languages based on the semantic analysis. A set of generated recommendations based on the language of the literary work may be analyzed. The set of generated recommendations may be filtered to display exclusively a recommendation in the language of the current literary work.

The list of recommendations may be organized based on a predetermined criteria for relevance. A higher priority may be given on the list to a particular recommendation when the predetermined criteria for relevance may be higher. Similarly, a lower priority may be given on the list to a particular recommendation when the predetermined criteria for relevance may be lower. The predetermined criteria for relevance may be based on in one or more embodiments a computerized algorithm created for relevance, a preference selected by the user, a language preference, the behavioral pattern of the user, the historical analysis of prior reading patterns of the user, the social graph of the user, the behavioral patterns of a set of similar users and a set of current events.

In one or more embodiments, a set of generated recommendations may be analyzed for a set of translations pertaining to the literary work. The set of generated recommendations may be filtered to omit the language of the current literary work to display exclusively a list of recommendations for translations in a set of foreign languages. The list of recommendations for translations may be organized based on a predetermined criteria for language preference.

The predetermined criteria for language preference may be based on one or more embodiments of a user preference for a particular set of languages, a computerized algorithm created for universal language preferences, a list of languages ranked by the number of speakers, a list of languages ranked by the number of users for a particular literary work, a list of languages based on the current geospatial location, a list of languages based on the original language of the particular literary work, a list of languages based on the nationality of an author of the particular literary work, a list of languages based on the nationality of a publisher of the particular literary work, a list of languages based on a popularity of the particular literary work in a particular language, the behavioral pattern of the user, the historical analysis of prior reading patterns of the user, the social graph of the user, the behavioral patterns of a set of similar users and a set of current events.

In one or more embodiments, a translation provider may be authorized as an authorized translation provider when the translation provider may have an agreement with a content owner associated with the literary work of authorship. The authorized translation provider may be permitted to generate an alternative translation data associated with the literary work. The alternative translation data may be automatically associated with the meta-data identifier information. The user may be permitted to select a preferred translation through the list indicator on the user interface of the rich-media player.

In one or more embodiments, a narration provider may be authorized as an authorized narration provider when the narration provider has an agreement with a content owner associated with the literary work of authorship. The authorized narration provider may be permitted to generate an alternative audio narration data associated with the literary work. A set of generated recommendations may be analyzed for a set of narrations pertaining to the literary work. The list of recommendations for translations may be organized based on the predetermined criteria for relevance. A higher priority may be given for a narration in the language of the literary work based on the semantic analysis. The user may be permitted to select a preferred narration through the list indicator on the user interface of the rich-media player.

In one or more embodiments, an authorized purchaser of the rich-media file may be permitted to record an individual narration of the literary work of authorship. The authorized purchaser of the rich-media file may be recognized as one of an authorized narration provider. A set of generated recommendations may also be analyzed for a type of external data pertaining to the literary work. The list of recommendations for the type of external data may be organized based on the predetermined criteria for relevance. The user may be permitted to access the recommendation through the indicator on the user interface of the rich-media player device.

The type of external data may be in one or more embodiments a translation data, a narration data, a graphics data, a video data, a music data, a purchase link, a fictional reading suggestion, a nonfictional reading suggestion and an information link. The purchaser link may be a link to a commerce portal displaying a list of suggested reading material for purchase accessible through the user interface of the rich-media player device.

In one or more embodiments, the recommendation may be automatically generated on the user interface of the rich-media player device through an alert. The alert may be situated adjacent to a content of the rich-media file on the user interface. The user may be permitted to select a preferred location for the alert based on a set of predefined automated alert-location options.

In one or more embodiments, a system may include a rich-media file which may store a literary work of authorship in an electronic medium of expression. A circuitry may be used to determine a content of the electronic medium of expression, to associate an external source of information with the content of the electronic medium of expression and to generate a set of recommendations based on one or more of a contextually relevant basis, a geospatially relevant basis and a user-centric basis. A filtering component may be used to organize the set of recommendations based on a predetermined criterion for relevance and a user interface to display the set of recommendations.

For example, if a user inputs for information on Hollywood on the user interface of the rich-media player device, the rich-media player device communicates with the rich-media file to generate meta-data relevant to Hollywood. The meta-data may be generated on contextually basis and/or on geospatial location basis and/or on user-centric basis. On contextual basis the rich-media player device may display the various authors who have written books on Hollywood, various published articles on Hollywood, the publication dates, publisher of the books, genre, category, theme etc. Regarding geospatial basis, the device may display predefined radius of the location Hollywood, a proximity to a landmark nearby Hollywood, etc.

What is claimed is:

1. A method comprising:
providing a rich-media file for a literary work of authorship in an electronic medium of expression;
generating a recommendation of an external source of information on at least one of a contextually relevant basis, a geospatially relevant basis, and a user-centric basis;
when the recommendation is contextually relevant, generating a contextually relevant suggestion based on a contextual meta-data associated with the literary work, wherein the contextual meta-data data is at least one of a word of the literary work, a phrase of the literary work, a sentence of the literary work, a paragraph of the literary work, a page of the literary work, a chapter of the literary work, a section of the literary work, a summary of the literary work, an author of the literary work, a publisher of the literary work, a retail price of the literary work, a subject of the literary work, a genre of the literary work, a category of the literary work, a publishing year of the literary work and a theme of the literary work;
when the recommendation is geospatially relevant, generating a geospatially relevant suggestion dynamically based on a meta-data associated with a current geo-spatial location of a rich-media player device presently displaying the literary work of authorship, wherein the meta-data associated with the current geo-spatial location is at least one of a specific geo-spatial location of the rich-media player, a predefined radius of the specific geo-spatial location of the rich-media player, a geospatial proximity to a landmark and a geospatial proximity to a user-specified location; and
when the recommendation is user-centric, generating a user-centric recommendation dynamically based on a reader meta-data associated with a profile of a user currently accessing the literary work of authorship through the rich-media player device, wherein the reader meta-data is at least one of a behavioral attribute of the user, a historical analysis based on previous reading history of the user, an interest of the user identified through self-identification and a social graph of the user.

2. The method of claim 1 further comprising:
refreshing the meta-data automatically when an update is transmitted to the rich-media player device while accessing the literary work of authorship.

3. The method of claim 1 wherein the behavioral attribute is at least one of a speed of reading a portion of the literary work of authorship, a scrolling speed, a display time and an access frequency of a page of the literary work.

4. The method of claim 1 wherein the historical analysis based on previous reading history of the user is at least one of an access frequency of a particular author, an access frequency of a particular genre, an access frequency of a particular subject matter, and an access frequency of a particular theme by the user of the rich-media device.

5. The method of claim 1 wherein the social graph of the user is at least one of a behavior of the user on a social community accessible through the rich-media device, a behavior of a set of individuals associated with the user on the social community, an attribute of the user associated with the social community, an attribute of the set of individuals associated with the user on the social community, a set of preferences voiced by the user on the social community, a set of preferences voiced by the set of individuals associated with the user on the social community, an age of the user, an age of the set of individuals associated with the user, a set of demographics of the user based on a usage of the social community, a set of demographics of the set of individuals associated with the user based on the usage of the social community, a set of trends of the user based on the usage of the social community, a set of trends of the set of individuals associated with the user based on the usage of the social community, a information based on a set of groups associated with the user on the social community accessible through the rich-media device.

6. The method of claim 1 further comprising:
determining a meta-data identifier information associated with the literary work of authorship;
associating a first relevant external data with the meta-data identifier information based on the contextual meta-data;
automatically generating the contextually relevant suggestion based on the first relevant external data through an indicator on a user interface of the rich-media player device; and
permitting the user to access the contextually relevant suggestion through the indicator on the user interface of the rich-media player.

7. The method of claim 6 further comprising:
generating a set of contextually relevant suggestions as a list on the user interface of the rich-media player device when a second relevant external data is detected; and
permitting the user to select a preferred suggestion through the list on the user interface of the rich-media player.

8. The method of claim 1 further comprising:
determining a language of a current literary work through a semantic analysis;
selecting an appropriate language from a list of predetermined languages based on the semantic analysis;
analyzing a set of generated recommendations based on the language of the literary work; and
filtering the set of generated recommendations to display exclusively a recommendation in the language of the current literary work.

9. The method of claim 8 further comprising:
organizing the list of recommendations based on a predetermined criteria for relevance;
giving a higher priority on the list to a particular recommendation when the predetermined criteria for relevance is higher; and
giving a lower priority on the list to a particular recommendation when the predetermined criteria for relevance is lower.

10. The method of claim 9 wherein the predetermined criteria for relevance is based on at least one of a computerized algorithm created for relevance, a preference selected by the user, a language preference, the behavioral pattern of the user, the historical analysis of prior reading patterns of the user, the social graph of the user, the behavioral patterns of a set of similar users and a set of current events.

11. The method of claim 10 further comprising:
analyzing a set of generated recommendations for a set of translations pertaining to the literary work;
filtering the set of generated recommendations to omit the language of the current literary work to display exclusively a list of recommendations for translations in a set of foreign languages; and
organizing the list of recommendations for translations based on a predetermined criteria for language preference.

12. The method of claim 11 wherein the predetermined criteria for language preference is based on at least one of a user preference for a particular set of languages, a computerized algorithm created for universal language preferences, a list of languages ranked by the number of speakers, a list of languages ranked by the number of users for a particular literary work, a list of languages based on the current geospatial location, a list of languages based on original language of the particular literary work, a list of languages based on the nationality of an author of the particular literary work, a list of languages based on the nationality of a publisher of the particular literary work, a list of languages based on a popularity of the particular literary work in a particular language, the behavioral pattern of the user, the historical analysis of prior reading patterns of the user, the social graph of the user, the behavioral patterns of a set of similar users and a set of current events.

13. The method of claim 12 further comprising:
authorizing a translation provider as an authorized translation provider when the translation provider has an agreement with a content owner associated with the literary work of authorship;
permitting the authorized translation provider to generate an alternative translation data associated with the literary work;
automatically associating the alternative translation data with the meta-data identifier information; and
permitting the user to select a preferred translation through the list indicator on the user interface of the rich-media player.

14. The method of claim 13 further comprising:
authorizing a narration provider as an authorized narration provider when the narration provider has an agreement with a content owner associated with the literary work of authorship;
permitting the authorized narration provider to generate an alternative audio narration data associated with the literary work;
analyzing a set of generated recommendations for a set of narrations pertaining to the literary work;
organizing the list of recommendations for translations based on the predetermined criteria for relevance;
giving a higher priority for a narration in the language of the literary work based on the semantic analysis; and
permitting the user to select a preferred narration through the list indicator on the user interface of the rich-media player.

15. The method of claim 14 further comprising:
permitting an authorized purchaser of the rich media file to record an individualized narration of the literary work of authorship; and
recognizing the authorized purchaser of the rich media file as one of an authorized narration provider.

16. The method of claim 15 further comprising:
analyzing a set of generated recommendations for a type of external data pertaining to the literary work;
organizing the list of recommendations for the type of external data based on the predetermined criteria for relevance; and
permitting the user to access the recommendation through the indicator on the user interface of the rich-media player device.

17. The method of claim 16 wherein the type of external data is at least one of a translation data, a narration data, a graphics data, a video data, a music data, a purchase link, a fictional reading suggestion, a nonfictional reading suggestion and an information link.

18. The method of claim 17 wherein the purchase link is a link to a commerce portal displaying a list of suggested reading material for purchase accessible through the user interface of the rich-media player device.

19. The method of claim 1 further comprising:
automatically generating the recommendation on the user interface of the rich-media player device through an alert;
situating the alert adjacent to a content of the rich-media file on the user interface; and
permitting the user to select a preferred location for the alert based on a set of predefined automated alert-location options.

20. A method comprising:
determining a contextually relevant meta-data associated with a rich-media file for a literary work of authorship in an electronic medium of expression;
determining a geospatially relevant meta-data associated with a current geo-spatial location of a rich-media player device presently displaying the literary work of authorship;
determining a reader meta-data associated with a profile of a user currently accessing the literary work of authorship through the rich-media player device;
associating an external source of information to at least one of the contextually relevant meta-data, the geospatially relevant meta-data and the reader meta-data; and
generating a recommendation based on the external source of information.

21. The method of claim 20 further comprising:
determining a meta-data identifier information associated with the literary work of authorship; and
associating the external source of information to the meta-data identifier information associated with the literary work of authorship.

22. The method of claim 21 further comprising:
analyzing a list of recommendations for a type of the external data associated with the literary work;
organizing the list of recommendations for the type of the external data based on a predetermined criteria for relevance; and
generating the list of recommendations through an alert on a user interface associated with the rich-media player device.

23. A system comprising:
a rich-media file to store a literary work of authorship in an electronic medium of expression;
a circuitry to determine a content of the electronic medium of expression, to associate an external source of information with the content of the electronic medium of expression and to generate a set of recommendations based on at least one of a contextually relevant basis, a geospatially relevant basis and a user-centric basis;
a filtering component to organize the set of recommendations based on a predetermined criteria for relevance; and
a user interface to display the set of recommendations.
